(19) United States
(12) Patent Application Publication
(10) Pub. No.: US 2024/0057224 A1
(43) Pub. Date: Feb. 15, 2024

(54) Heating Oven for an Aerosol Generating Device Having Heater Plates, Aerosol Generating Device Having a Heating Oven and Method of Assembling a Heating Oven

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 18/278,569

(22) PCT Filed: Feb. 23, 2022
(86) PCT No.: PCT/EP2022/054516

§ 371 Date: Aug. 23, 2023

(30) Foreign Application Priority Data
Feb. 24, 2021 (EP) 21158910.6
Feb. 24, 2021 (EP) 21158911.4
Feb. 24, 2021 (EP) 21158912.2
Feb. 24, 2021 (EP) 21158913.0
Feb. 24, 2021 (EP) 21158915.5

(51) Int. Cl. H05B 3/44; A24F 40/70; A24F 40/46; A24F 40/465; A24F 40/20

(52) U.S. Cl. CPC H05B 3/44; A24F 40/70; A24F 40/46; A24F 40/465; A24F 40/20; H05B 2203/017

(57) ABSTRACT

A heating oven for an aerosol generating device includes a tubular member including a first end and a second end and at least one planar support wall extending across the internal tubular cavity of the tubular member between the first and second ends, at least one planar heater attached to the planar support wall including electrical connections extending through the second end of the tubular member and, at least one closure configured for at least partially closing the second end. An aerosol generating device includes at least one such heating oven. In a method of assembling a heating oven for an aerosol generating device, a tubular member having two open ends is provided, at least one planar support wall having a planar heater attached thereto is inserted through one of the open ends, and one end is closed with electrical connections extending through a closure.

### TECHNICAL FIELD

The invention relates to a heating oven for an aerosol generating device, an aerosol generating device having such an oven and a method of assembling a heating oven.

### TECHNICAL BACKGROUND

Aerosol generating devices have become popular as a replacement for conventional smoking articles, such as cigarettes. In such devices, an aerosol is heated, which is usually achieved by means of a generally tubular oven, around which a thin film heater is wrapped. An aerosol forming article, for example a tobacco substrate stick is inserted into the tubular heater and heated. The conventional thin film heaters require a number of at least partially manual assembling operations.

This also applies to curved heating plates as shown in CN 209995365 U. Further, the method of bringing a moveable heating plate as shown in EP 3 228 199 B1 in contact with a tobacco substrate stick is relatively complicated. Finally, CN 109965350 A shows a polygonal support tube with heater plates fixed to the outside.

### SUMMARY OF THE INVENTION

Against this background, it is an object underlying the invention to provide an oven for an aerosol generating device which is easy and inexpensive to manufacture and, at the same time, maintains the necessary heat transfer.

This object is solved by the subject-matter of claim 1, according to which the oven has a tubular member and at least one planar support wall extending across the internal tubular cavity thereof. At least one planar heater is attached to the planar support wall, and electrical connections extend through a second end of the tubular member, which can be closed by an appropriate closure. Such an oven turns out to be easy to manufacture and at the same time the necessary heat transfer to a stick inserted into the tubular member can be ensured by means of contact with the support wall, to which the planar heater is attached. Further, the configuration can be simplified by means of the fact that the heater mass can be reduced to the points of contact with the stick. Further, there is, as compared to conventional heating ovens, less need for insulation, as the tubular member acts as a first insulation material. In particular, undesired heat transfer to the tubular member (not to the stick) can be minimized due to the fact that contact between the planar heater and the tubular member is limited to a line contact for example along suitable rails provided between the tubular member and the planar heater.

The tubular member can for example have a circle cylindrical shape and can for example have rails on the inside for allowing insertion of planar heaters and/or planar support walls having at least one planar heater attached thereto. The planar heater can for example be provided as rectangular plates. As regards the number of heater plates, three are currently preferred, but two or four are generally also possible and within the scope of the invention, as would be a single heater plate or five or more heater plates.

As regards the airflow, there is advantageously no difference as compared to conventional airflow configurations which have proven efficient. However, the airflow can be more easily arranged as a result of the particular arrangement of the planar support wall in the tubular member. In particular, an airflow path may be arranged between the tubular member and the at least one planar support wall. The airflow path may further comprise an air inlet at the first end and/or a flow passage between the airflow path and the internal tubular cavity. The flow passage may be formed in the planar support wall, e.g. as a passage traversing the support wall, typically near the bottom of the cavity, and/or in the closure allowing air to enter in the stick. In any case, air can communicate with the cavity, where the stick is located.

Preferred embodiments are described in the further claims.

In accordance with a simple structure, the planar heater essentially separates a central cavity portion of the tubular member from a peripheral cavity portion thereof, and the central cavity portion is preferably of higher volume than the peripheral cavity portion. In this manner, the central cavity portion can be made sufficiently large for accommodating the stick, and the peripheral cavity portion which allows mounting of the planar heater and contributes to insulation, can be provided but does not significantly increase the size of the tubular member as a whole. The peripheral cavity portion may serve as an airflow path as aforementioned.

In connection with a relatively simple structure of the planar heater, it can comprise a plate and a heating element attached thereto.

In a particularly efficient manner, the heater can comprise a heater track printed on ceramic material or a metal plate. The heater may also be a resistive heating fibre mat or grid or be a heating layer coated on the plate. The heating coating may be chemically bonded on an electrically insulating material of the plate. For example, the coating of electrically conductive material is metal, metal oxide or carbon. The plate may be a heat resistant plate such as made of PEEK or a metal with a coated of electrically insulating layer as described in co-pending EP21155871.3.

In first simulations, both a structure, in which the heating element faces the central cavity portion, or the alternative structure, in which the heating element faces the peripheral cavity portion has turned out to be efficient for heating a stick accommodated in the central cavity portion. When the heating element faces the central cavity portion, heat transfer can advantageously be maximized.

In order to enable a particularly easy manufacture, the planar support wall can comprise a pair of guiding members, such as rails, configured for insertion of the planar heater therethrough. Similarly, the tubular member can have one or more pair(s) of such guiding members configured for insertion of the support wall(s).

The planar heater may comprise a metal shield. The metal shield may be attached to the planar heater. The metal shield may be arranged and dimensioned so as to cover the whole or a part of the side face of the planar heater that faces the central cavity portion. Alternatively, the metal shield may be arranged and dimensioned so as to cover the whole or a part of the side face of the planar heater that faces the peripheral cavity portion. It is also conceivable that two metal shields are provided, one on each side face of the planar heater. The metal shield may be a metal sheet having a thickness smaller than the thickness of the planar heater. The metal shield may have a bent part at the first end of the tubular member, the bent part being bent with respect to the rest of the metal shield. The bent part may have a round edge.

By attaching a metal shield to the planar heater, the planar heater can be protected from physical impact, which may be particularly important in case of the planar heater comprising a ceramic material. Moreover, with this configuration, the planar heater has better sliding properties due to provision of the metal shield, thereby, for example, leading to an easier insertion of the planar heater.

The features relating to the metal shield may be applied to the configurations of the second to fifth aspects of the present disclosure/invention, described below.

In order to increase heating efficiency and allow individual heating patterns, the tubular member can comprise at least two planar support walls extending across the internal cavity thereof, each planar support wall comprising at least one planar heater. The two planar support walls can be provided in parallel to each other, so that they can efficiently heat the stick from two opposite sides.

In this configuration, the planar heaters can be mounted in series or in parallel, in order to provide different heating patterns. In this context, even when several heaters are provided and are configured to work at the same time, providing them separately simplifies assembly of the oven.

Efficient heating can be provided by both a planar heater, which is resistive and a heating element being inductive, in other words both resistive and/or inductive heaters.

As regards safe mounting of the heating element, an electrically insulating layer can be provided between the support plate and the heating element.

In this context, an electrically insulating polymer or ceramic or DLC can be preferred for the electrically insulating layer. The heating element can also be glued to the support plate, e.g. by a silicone adhesive. The heating element can also be directly applied on the support plate such as by an electrically insulating coating (e.g. DLC) and a resistive layer (e.g. Titanium) directly printed or deposited on the coating.

As regards to the shape of its outer wall, the tubular member may have a substantially circular profile or, even if less preferred, other forms such as square, polygonal or oblong.

As regards the materials of the tubular member and the closure, these can be made of heat resistant plastic, such as PEEK or silicone, metal, such as stainless steel, or a combination thereof.

As regards the shape of the closure, a lid or a plug has turned out to be beneficial. A separate lid or plug facilitates the production of the tubular member and the assembling method of the device.

The invention further provides a method of assembling a heating oven for an aerosol generating device, in which a tubular member having two open ends is provided, so that one or more planar heaters can be inserted through one of the open ends, which is then closed, preferably by the closure such as a lid or plug, while allowing electrical connections to pass through. The other end, herein called first end, remains open for allowing a stick to be inserted.

In this context, it is expected that the assembly will exhibit a low variance.

### Further Aspects of the Present Disclosure/Invention

In addition to the invention described above, the present disclosure/invention further relates to the following inventive aspects. In this respect, the invention described above can be considered as the first aspect of the present disclosure/invention and the following aspects are respectively denoted as second to fifth aspects.

It is to be understood that a feature of one of the second to fifth aspects denoted with the same term as or structurally and/or functionally corresponding to a feature described above in context with the first aspect can have the same characteristics as the respective feature of the first aspect. Likewise, a feature described above in context with the first aspect and denoted with the same term as or structurally and/or functionally corresponding to a feature of one of the second to fifth aspects can have the same characteristics as the respective feature of the one of the second to fifth aspects. In particular, this may apply to the tubular member, the separation wall, and the heater/heating element/planar heater. In particular, the planar heater of the first and fifth aspects may be the same as or may correspond to the heater of the second and third aspects, and vice versa. Likewise, the planar heater of the first and fifth aspects and the heater of the second and third aspects may be the same as or may correspond to the heating element of the fourth aspect, and vice versa.

The features pertaining to one aspect may be independent from the features pertaining to another aspect or may be combined with the features pertaining to the other aspect.

### Second Aspect

### Technical Field

The second aspect relates to a heating oven for an aerosol generating device and an aerosol generating device and system having such an oven.

### Technical Background

Aerosol generating devices have become popular as a replacement for conventional smoking articles, such as cigarettes. In such devices, an aerosol is heated, which is usually achieved by means of a generally tubular oven, around which a thin film heater is wrapped. An aerosol forming article, for example a tobacco substrate stick is inserted into the tubular heater heated. The conventional thin film heaters require a number of at least partially manual assembling operations.

This also applies to curved heating plates as shown in CN 209995365 U. Further, the method of bringing a moveable heating plate as shown in EP 3 228 199 B1 in contact with a tobacco substrate stick is relatively complicated. Finally, CN 109965350 A shows a polygonal support tube with heater plates fixed to the outside.

### Summary of the Second Aspect

Against this background, it is an object underlying the second aspect to provide an oven for an aerosol generating device which is easy and inexpensive to manufacture and, at the same time, provides a controlled pressure drop.

This object is solved by the subject-matter of item 1 of the second aspect, according to which the oven has a tubular member and at least one separation wall fixed to and extending across the internal tubular cavity thereof. The separation wall as such can, depending on its thickness and material, be slightly resilient. At least one heater is attached to the separation wall, and electrical connections can extend through a second end of the tubular member, which can be closed by an appropriate closure. Such an oven turns out to be easy to manufacture and at the same time the necessary heat transfer to a stick inserted into the tubular member can be ensured by means of contact with the separation wall, to which the heater is attached. Efficient heating can be provided by both a planar heater, which is resistive and a heating element being inductive, in other words both resistive and/or inductive heaters.

Further, the separation wall separates a heating cavity for insertion of an aerosol generating article, such as a tobacco substrate stick, from an airflow cavity. The airflow cavity is open at the first end of the tubular member and communicates with the heating cavity at the second end so as to allow air to flow from the airflow cavity to the heating cavity. Thus, by appropriately designing this airflow, the desired pressure drop can be achieved. In particular, any influence of the stick position on the airflow and, as a consequence, pressure drop, can be significantly reduced. In other words, the stick position can be well defined, in particular it can be brought in efficient heat transferring contact with the one or more heaters provided on the one or more separation walls. Independent of the stick position, the airflow path and pressure drop are defined by the position and structure of the separation wall(s) separating the heating cavity from the airflow cavity. As a consequence, the pressure drop is significantly stabilized. Moreover, the air contact to the outer paper wrapper can be reduced thereby preventing a pronounced papery taste.

Again, in other words, the typically planar separation wall separates a central cavity portion of the tubular member forming the heating cavity from a peripheral cavity portion thereof forming the airflow cavity, and the central cavity portion is preferably of higher volume than the peripheral cavity portion. In this manner, the central cavity portion can be made sufficiently large for accommodating the stick, and the peripheral cavity portion which allows mounting of the typically planar heater and contributes to insulation, which can be provided but does not significantly increase the size of the tubular member as a whole. The tubular member can for example have a circle cylindrical shape and can for example have rails on the inside for allowing insertion of planar heaters and/or planar separation walls having at least one planar heater attached thereto. The planar heater can for example be provided as rectangular plates.

Preferred embodiments of the second aspect are described in the further itemized subjects of the second aspect.

Although the separation wall can generally have any suitable shape, an essentially planar separation wall is currently preferred as it can be manufactured particularly easily and efficiently fulfils the purpose thereof.

In order to increase heating efficiency and allow individual heating patterns, the tubular member can comprise at least two separation walls extending across the internal cavity thereof, each separation wall comprising at least one heater. The two planar separation walls can be provided in parallel to each other, so that they can efficiently heat the stick from two opposite sides. Corresponding to the above first described separation wall, the second separation wall separates a second airflow cavity from the heating cavity.

One or more separation walls can comprise a second heater or additional heaters. In any case, when two or more heaters are present, they can be mounted in series or in parallel, in order to provide different heating patterns. In this context, even when several heaters are provided and are configured to work at the same time, providing them separately simplifies assembly of the oven.

In view of a simple structure, it is presently preferred for two separation walls to be opposed and preferably symmetrically arranged on each side of a longitudinal axial plane of the tubular member of the heating oven. The separation walls are arranged at a distance allowing a stick of diameter larger than the distance between the separation walls to be deformed and compressed in the insertion position between the first and second heaters.

In order to enable a particularly easy manufacture, the tubular member can comprise at least one pair of guiding members, such as rails, configured for insertion of the separation wall.

In connection with a relatively simple structure of the heater, it can comprise a plate and a heating element attached thereto. In first simulations, both a structure, in which the heating element faces the central cavity portion or the alternative structure, in which the heating element faces the peripheral cavity portion has turned out to be efficient for heating a stick accommodated in the central cavity portion. When the heating element faces the central cavity portion, heat transfer can advantageously be maximized. In case the heating element faces the peripheral cavity portion, higher convection heating can be obtained on air flowing in the cavity. With this configuration, the air flowing in the peripheral cavity portion can be pre-heated before it enters the stick from below, thereby leading to an improved heating of the stick. It is also conceivable to have at least one heater facing the central cavity and at least one second heater facing the peripheral cavity and enable the two heaters to be controlled independently. The internal heater would heat more by conduction to the stick, whereas the external heater would heat more air by convection. As regards the number of heater plates, three are currently preferred, but two or four are generally also possible and within the scope of the second aspect, as would be a single heater plate or five or more heater plates.

It is also conceivable to provide a structure, in which two heating elements are provided on the plate of the heater, so that one heating element may be provided on a side of the plate that faces the central cavity portion and another heating element may be provided on a side of the plate that faces the peripheral cavity portion. With this configuration, heating by convection and heating by conduction are beneficially combined in one heater.

The heating element provided on the side of the plate that faces the peripheral cavity portion may be longer along the longitudinal axis than the heating element provided on the side of the plate that faces the central cavity portion. In particular, the heating element provided on the side of the plate that faces the peripheral cavity portion may be 10%, preferably 20%, more preferably 30%, longer than the heating element provided on the side of the plate that faces the central cavity portion. The reason is that the air flow passage in the peripheral cavity portion is longer than in the central cavity portion in a region which is occupied by the tobacco portion of the stick. With this configuration, proper pre-heating of the air flowing in the peripheral cavity portion can be ensured.

As in case for the first aspect described above, the heater may comprise a ceramic plate or a metal plate on which the heating element can be provided, such as a heater track printed on the ceramic plate. As such, a double-sided ceramic heater, having heating elements on both sides thereof as described above, may be provided, achieving the above advantages.

The features relating to the double-sided heater may be applied to the configurations of the first and third to fifth aspects.

In order to appropriately design and advantageously vary the pressure drop, the heating oven can comprise a flow control member configured for varying the flow section of the airflow cavity. In other words, any cross-sectional area defining the airflow cavity can be varied, possibly by the user, in order to find the individually most suitable flow section and resulting pressure drop.

In this context, the flow control member can be manually movable between a first flow section and a second flow section of different, in particular reduced pressure drop. Preferably, the pressure drop can be controlled within a range between 40 and 120 mmH2O, preferably 50 and 90 mmH2O.

It provides further advantages with regard an ease of use, if the flow control member is rotatable.

As regards efficient manufacture of the heating oven described herein the tubular member mentioned above can be formed of a deep drawn piece of material such as steel or aluminium. In an alternative, the tubular member can be formed of an extruded piece of material such as steel, aluminium or heat resistant polymer.

As regards safe mounting of the heating element, an electrically insulating layer can be provided between the support plate and the heating element.

In this context, an electrically insulating polymer or ceramic or DLC can be preferred for the electrically insulating layer. The heating element can also be glued to the support plate, e.g. by a silicone adhesive. The heating element can also be directly applied on the support plate such as by an electrically insulating coating (e.g. DLC) and a resistive layer (e.g. Titanium) directly printed or deposited on the coating.

The closure, lid or plug also mentioned above this can be made of a separate element mechanically attached, for example press fitted, or welded to the tubular member, or it can efficiently be provided as an integral part of the tubular member.

As regards the materials of the tubular member and the closure, these can be made of heat resistant plastic, such as PEEK or silicone, metal, such as aluminium or stainless steel, or a combination thereof.

While the heaters have been described above to be in direct contact with the (tobacco substrate) stick to thereby allow direct heat transfer to the stick, it is also conceivable to adopt a configuration in which the heater may be spaced apart from the stick, when the stick is inserted in the tubular member. For example, a smallest distance between the stick and the heater in a direction perpendicular to the direction along the longitudinal axis of the tubular member may be at least 0.1 mm, preferably at least 0.3 mm, more preferably at least 0.5 mm, and most preferably at least 0.7 mm, preferably less than 1.5 mm, more preferably less than 1.2 mm, most preferably about (1.0+/−0.1) mm.

With this configuration, a more homogeneous heating of the stick can be achieved. Moreover, this configuration prevents overheating of parts of the stick, reduces off-taste, and can improve the quality of the emissions of the aerosol generating device.

In order to adopt a configuration in which the heater is spaced apart from the stick, the separation wall, comprising the heater, may be spaced further away from the stick than in a case in which the heater is in direct contact with the stick. In this case, in order to still ensure that the air is guided and flows through the peripheral cavity portion, in order to be properly preheated, and not through a gap formed between the stick and the heater, the heating oven may comprise an air-blocking part provided between the first end and the second end of the tubular member, and at least one air passage opening provided between the air-blocking part and the first end of the tubular member, wherein the at least one air passage opening is configured to allow communication between the outside, for example, the outside of the heating oven, and the peripheral cavity portion (airflow cavity).

In case of a cylindrical stick, the air-blocking part may have the shape of a ring, i.e. the air-blocking part may be an air-blocking ring. The air-blocking part may generally be configured and dimensioned to block air from flowing into or entering a gap between the stick and the heater, at the position of the air-blocking ring. In case of a cylindrical stick, the air-blocking ring may have an inner radius smaller than an outer radius of the cylindrical stick.

The air-blocking part may be formed as an integral part of the separation wall or may be formed as a portion at a separate part attached to the separation wall, for example, at the first end of the tubular member.

Generally, the location of the air-blocking part may be between the first and the second end of the tubular member. However, in order to ensure proper preheating of the air flowing in the peripheral cavity portion, it is preferable to arrange the air-blocking part at a position closer to the first end that to the second end of the tubular member, and, in particular in close proximity to the first end. The air-blocking part may also be arranged at the first end of the tubular member.

The air passage opening may be an opening of any shape, as long as it allows communication between the outside, for example, the outside of the heating oven, and the peripheral cavity portion. For example, the air passage opening may have a circular or an oval shape.

More than one air passage opening may be provided in the heating oven. For example, in case the air-blocking part is formed as an integral part of the separation wall, the one or more than one air passage opening may be provided in the separation wall. In case the air-blocking part is formed as a portion at a separate part attached to the separation wall, the one or more than one air passage opening may be provided in the separate part. The air passage opening may be provided at the first end of the tubular member.

For example, the heating oven may adopt a configuration in which the at least one air passage opening is provided at a position located further away from a central, longitudinal axis of the tubular member than a contact point between the air-blocking part and the stick, when the stick is inserted in the tubular member. This allows air from the outside to enter the peripheral cavity portion through the air passage opening, through an air passage in the heating oven formed in a region behind the air-blocking part, as seen in a direction from the central, longitudinal axis of the tubular member, i.e. in a region between the air-blocking part and the tubular member.

Further features of the air-blocking part and the air-passage opening will become apparent when considering the drawings and accompanying description.

With this configuration of the air-blocking part and the air passage opening, the air is forced to flow through the air passage opening directly to the side of the heaters facing away from the stick. This allows proper pre-heating of the air and leads to a more homogeneous heating of the stick, prevents overheating of parts of the stick, reduces off-taste, and improves the quality of the emissions of the aerosol generating device.

The features relating to the air-blocking part and the air passage opening may be applied to the configurations of the first and third to fifth aspects.

As also indicated above, the second aspect further provides an aerosol generating device comprising a control unit and an electrical support unit and a housing comprising an oven as described herein.

In this context, heat transfer to the tobacco stick can be further improved by providing an insulating member surrounding the oven. For example, the insulating member may be a vacuum sleeve or fibre-containing casing such as ceramic.

Finally, an aerosol generating system as described herein comprises an aerosol generating device as described above and an aerosol substrate in the form of a rod or a stick at least partially inserted into the heating oven, wherein the aerosol substrate is sized so as to be deformed and compressed by the one or more separation wall(s).

### Third Aspect

### Technical Field

The third aspect relates to a heating oven for an aerosol generating device and an aerosol generating device having such an oven.

### Technical Background

Aerosol generating devices have become popular as a replacement for conventional smoking articles, such as cigarettes. In such devices, an aerosol is heated, which is usually achieved by means of a generally tubular oven, around which a thin film heater is wrapped. An aerosol forming article, for example a tobacco substrate stick is inserted into the tubular heater and heated. The conventional thin film heaters require a number of at least partially manual assembling operations.

This also applies to curved heating plates as shown in CN 209995365 U. Further, the method of bringing a moveable heating plate as shown in EP 3 228 199 B1 in contact with a tobacco substrate stick is relatively complicated. Finally, CN 109965350 A shows a polygonal support tube with heater plates fixed to the outside.

WO 201150964 A1 relates to a rolled heating element comprising a tubular electrically insulating substrate and a heating track on the inside or outside of the electrically insulating substrate. The aerosol-forming substrate can be inserted in the tubular electrically insulating substrate while the heating track surrounds or partially surrounds the aerosol-forming substrate.

EP 3337344 A is related to a cartridge with a separation wall to define first and second compartments 11, 12 for aerosolisable substances (e.g. nicotine source and second substance source). The compartments may be heated by first and second internal susceptors.

### Summary of the Third Aspect

Against this background, it is an object underlying the third aspect to provide an oven for an aerosol generating device which is robust and inexpensive to manufacture and, at the same time, maintains the necessary heat transfer.

This object is solved by the subject-matter of item 1 of the third aspect, according to which the oven has a tubular member and at least one planar support wall extending across the internal tubular cavity thereof. At least one planar heater is attached to the planar support wall, and the planar support wall is fixed to the tubular member by means of a mechanical fixture. This will provide sufficient mechanical strength to resist a high number, for example, thousands of substrate-stick insertions. At the same time, a mechanical fixture will have sufficient resistance to high temperature cycles and environmental changes, such as varying humidity. Moreover, a mechanical fixture facilitates manufacturability of the oven.

Various concepts of such a mechanical fixture are conceivable with particularly advantageous properties currently being expected from a plurality of lugs and recesses provided on the sides of the planar support wall and typically two complementary elements at the inner surface of the tubular member, such as rails. These lugs and recesses can be formed similar to those known from cable ties, so that the planar support wall can be inserted easily, for example, until it reaches a stop, and is then locked against any movement in the opposite direction, i.e. out of the tubular member. In this manner, any force acting on the planar support wall when removing a stick will not remove the planar support wall. At the same time, due to the stop or a similar structure, inserting a stick will also not move the planar support wall in an undesirable matter.

Thus, sufficient mechanical strength is ensured, while the heating oven remains easy to assemble. Moreover, compared for example to gluing the planar support wall to the tubular member, a low impact by temperature and environmental changes as indicated above can be expected.

Electrical connections can extend through a second end of the tubular member, which can be closed by an appropriate closure. Such an oven turns out to be easy to manufacture and at the same time the necessary heat transfer to a stick inserted into the tubular member can be ensured by means of contact with the support wall, to which the planar heater is attached. Further, the configuration can be simplified by means of the fact that the heater mass can be reduced to the points of contact with the stick. Further, there is, as compared to conventional heating ovens, less need for insulation, as the tubular member acts as a first insulation material. In particular, undesired heat transfer to the tubular member (not to the stick) can be minimized due to the fact that contact between the planar heater and the tubular member is limited to a line contact for example along suitable rails provided between the tubular member and the planar heater.

The tubular member can for example have a circle cylindrical shape and can for example have rails on the inside for allowing insertion of planar heaters and/or planar support walls having at least one planar heater attached thereto. The planar heater can for example be provided as a rectangular plate. As regards the number of heater plates, three are currently preferred, but two or four are generally also possible and within the scope of the third aspect, as would be a single heater plate or five or more heater plates.

As regards the airflow, there is advantageously no difference as compared to conventional airflow configurations which have proven efficient.

Preferred embodiments of the third aspect are described in the further itemized subjects of the third aspect.

In connection with a relatively simple structure of the planar heater, it can comprise a plate and a heating element attached thereto. In a particularly efficient manner, the heater can comprise a heating track for example printed on ceramic material or a metal plate. The heater may also be a resistive heating fibre mat or grid or be a heating layer coated on the plate. The heating coating may be chemically bonded on an electrically insulating material of the plate. For example, the coating of electrically conductive material is metal, metal oxide or carbon. The plate may be a heat resistant plate such as made of PEEK or a metal with a coated of electrically insulating layer as described in co-pending EP21155871.3.

In order to enable a particularly easy manufacture, the tubular member can comprise at least one pair of guiding members, such as rails, configured for insertion of the planar support wall with the heater therebetween. Similarly, the planar support wall can have one or more pair of such guiding members configured for insertion into the tubular member.

With regard to the robust and at the same time easy to manufacture heating oven including mechanically fixed support walls, it has proven efficient to form the tubular member and/or at least one planar support wall of resilient material, such as plastic, PEEK, or metal.

As regards the materials of the tubular member and/or the planar support wall, these can advantageously be made of heat resistant plastic, such as PEEK, metal, such as stainless steel, or a combination thereof.

As already indicated above, the mechanical fixture can for example be a clamping fixture, which turns out to be both robust and easy to manufacture.

The mechanical fixture can comprise at least two clamping rings spaced apart along an axial length of the tubular member, between which the planar support wall can be clamped.

Assembly can be made particularly easy, when at least one of the clamping rings is self-locking.

In order to increase heating efficiency and allow individual heating patterns, the tubular member can comprise at least two planar support walls extending across the internal cavity thereof, each planar support wall comprising at least one planar heater. The two planar support walls can be provided in parallel and in particular symmetrical to each other, so that they can efficiently heat the stick from two opposite sides.

In this configuration, the planar heaters can be mounted in series or in parallel, in order to provide different heating patterns. In this context, even when several heaters are provided and are configured to work at the same time, providing them separately simplifies assembly of the oven.

Efficient heating can be provided by both a planar heater, which is resistive and such a heater being inductive.

As regards the shape of the closure, a lid or a plug has turned out to be beneficial.

In accordance with a simple structure, the support wall(s) with the planar heater(s) essentially separates a central cavity portion of the tubular member from one or more peripheral cavity portions thereof, and the central cavity portion is preferably of higher volume than the peripheral cavity portion. In this manner, the central cavity portion can be made sufficiently large for accommodating the stick, and the peripheral cavity portion which allows mounting of the planar heater and contributes to insulation, can be provided but does not significantly increase the size of the tubular member as a whole.

In first simulations, both a structure, in which the heating element faces the central cavity portion, or the alternative structure, in which the heating element faces the peripheral cavity portion has turned out to be efficient for heating a stick accommodated in the central cavity portion. When the heating element faces the central cavity portion, heat transfer can advantageously be maximized. In case the heating element faces the peripheral cavity portion, higher convection heating can be obtained on air flowing in the cavity. It is also conceivable to have at least one heater facing the central cavity and at least one second heater facing the peripheral cavity and enable the two heaters to be controlled independently. The internal heater would heat more by conduction to the stick, whereas the external heater would heat more air by convection.

The present disclosure further provides a method of assembling a heating oven for an aerosol generating device, in which a tubular member having two open ends is provided, so that one or more planar support walls with heaters can be inserted through one of the open ends and mechanically fixed in place. The tubular member can then be closed while allowing electrical connections to pass through. The other end, herein called first end, remains open for allowing a stick to be inserted.

In this context, it is expected that the assembly will exhibit a low variance.

The third aspect further provides an aerosol generating device comprising a control unit, an electrical supply unit and a housing comprising a heating oven as described herein. In this context, thermal insulation can be improved by surrounding the oven by a thermal insulating member.

### Fourth Aspect

### Technical Field

The fourth aspect relates to a heater for an aerosol generating device and an aerosol generating device having such a heater.

### Technical Background

Aerosol generating devices have become popular as a replacement for conventional smoking articles, such as cigarettes. In such devices, an aerosol is heated, which is usually achieved by means of a generally tubular heater, around which a thin film heater is wrapped. An aerosol forming article, for example a tobacco substrate stick is inserted into the tubular heater heated. The conventional thin film heaters require a number of at least partially manual assembling operations.

This also applies to curved heating plates as shown in CN 209995365 U. Further, the method of bringing a moveable heating plate as shown in EP 3 228 199 B1 in contact with a tobacco substrate stick is relatively complicated. Finally, CN 109965350 A shows a polygonal support tube with heater plates fixed to the outside.

CN 110638113 A is related to a heat insulation system comprising a heating pipe and an outer heat insulation pipe, which are connected by supporting pieces having ribs. U.S. Pat. No. 10,368,582 B2 shows a heating element for an e-cigarette comprising a heating support, which can be a rigid cylinder or square of ceramic material and can have depressions or recesses in its surface. Finally, WO 201150964 A1 is related to a heater for an aerosol generating device comprising a flat insulating substrate having conductive tracks.

### Summary of the Fourth Aspect

Against this background, it is an object underlying the fourth aspect to provide a heater for an aerosol generating device which is easy and inexpensive to manufacture and, at the same time, provides the necessary stability and strength while maintaining relatively low thermal mass.

This object is solved by the subject-matter of item 1 of the fourth aspect, according to which the heater has a support plate and at least one typically entirely flat heating element attached to the support plate. The support plate is substantially cuboid with a length, a width and a thickness, the thickness being smaller than the length and the width. In order to increase rigidity of the support wall, it presents locally at least one embossing. The embossing can for example form one or more preferably straight ribs, ridges or webs so as to increase rigidity against bending. At the same time, usage of material and, as a consequence, the mass is kept low, since the plate thickness is essentially maintained also in the area of the one or more embossing. In other words, the embossing exhibits a concave shape on one side of the plate and a convex shape on the other, opposite side. Increased rigidity is particularly efficient for maintaining firm contact with a tobacco stick inserted, so that efficient heat transfer is achieved.

Such a heater turns out to be easy to manufacture and at the same time the necessary heat transfer to a stick inserted into the tubular member can be ensured by means of contact with the support plate, to which the heating element is attached. Further, the configuration can be simplified by means of the fact that the heater mass can be reduced to the points of contact with the stick. Further, there is, as compared to conventional heaters, less need for insulation, as a tubular member of the heater can act as a first insulation material.

Preferred embodiments of the fourth aspect are described in the further itemized subjects of the fourth aspect.

As regards the materials of the support plate, it can be made of high heat resistant plastic, such as PEEK, metal, in particular stainless steel, or a combination thereof.

By means of the fourth aspect, the thickness of the support plate can advantageously be kept very low, namely lower than 0.5 mm, preferably lower than 0.1 mm and most preferably at about 0.07 mm.

The embossing may form, as mentioned, an essentially straight rib, which has a length, which can advantageously extend in the length or axial direction of the heater. When the heater is considered tubular, the length direction thereof corresponds to a length of the tube. Superior rigidity against bending can, however, also be achieved by means of at least one embossing extending at an angle, in particular essentially perpendicular to the length direction.

By means of first simulations it was found, that the advantages in accordance with the fourth aspect can be used both when the embossing protrudes towards the closest wall of the heater and when it protrudes in the opposite direction, i.e. towards a tobacco stick to be inserted into the heater.

As regards suitable shapes of at least one embossing, in particular a rib, viewed in cross-section, V- or U-shapes have turned out to be beneficial.

As regards attachment of the heating element, this is not affected by any embossing, since it can at least partially overlap therewith when seen in the thickness direction.

Efficient heating can be provided by both a heating element, which is resistive and a heating element being inductive, in other words both resistive and/or inductive heaters.

As regards safe mounting of the heating element, an electrically insulating layer can be provided between the support plate and the heating element.

In this context, an electrically insulating polymer or ceramic or DLC can be preferred for the electrically insulating layer. The heating element can also be glued to the support plate, e.g. by a silicone adhesive. The heating element can also be directly applied on the support plate such as by an electrically insulating coating (e.g. DLC) and a resistive layer (e.g. Titanium) directly printed or deposited on the coating.

As already indicated, stability can advantageously be balanced with usage of material and mass, when the embossing has a maximum height larger than the thickness of the support plate.

As indicated before, the heater described herein is particularly suitable for a heating oven for an aerosol generating device which has a tubular member with two ends.

The heater extends in the tubular member between the two ends.

In this context, the heater is suitably attached to the inner wall of the tubular member. As also indicated before, the length of the heater extends along the axial direction of the tubular member in this embodiment of the fourth aspect.

In accordance with a simple structure, the heating element essentially separates a central cavity portion of the tubular member from a peripheral cavity portion thereof, and the central cavity portion is preferably of higher volume than the peripheral cavity portion. In this manner, the central cavity portion can be made sufficiently large for accommodating the stick, and the peripheral cavity portion which allows mounting of the heating element and contributes to insulation can be provided but does not significantly increase the size of the tubular member as a whole. In connection with a relatively simple structure of the heating element, it can comprise a plate and a heating element attached thereto. The tubular member can for example have a circle cylindrical shape and can for example have rails on the inside for allowing insertion of heating elements and/or support plates having at least one heating element attached thereto. The heating element can for example be provided as rectangular plates.

In first simulations, both a structure, in which the heating element faces the central cavity portion of the alternative structure, in which the heating element faces the peripheral cavity portion has turned out to be efficient for heating a stick accommodated in the central cavity portion. When the heating element faces the central cavity portion, heat transfer can advantageously be maximized. In case the heating element faces the peripheral cavity portion, higher convection heating can be obtained on air flowing in the cavity. It is also conceivable to have at least one heater facing the central cavity and at least one second heater facing the peripheral cavity and enable the two heaters to be controlled independently. The internal heater would heat more by conduction to the stick, whereas the external heater would heat more air by convection.

In order to enable a particularly easy manufacture, the support plate can comprise a pair of guiding members, such as rails, configured for insertion of the heating element therethrough. The same applies to the tubular member optionally having guide members configured for insertion of the support plate.

In order to increase heating efficiency and allow individual heating patterns, the tubular member can comprise at least two support plates extending across the internal cavity thereof, each support plate comprising at least one heating element. The two support plates can be provided in parallel to each other, so that they can efficiently heat the stick from two opposite sides. In this context, even when several heaters are provided and are configured to work at the same time, providing them separately simplifies assembly of the heater.

In this configuration, the heating elements can be mounted in series or in parallel, in order to provide different heating patterns.

As regards a closure of the tubular member, a lid or a plug has turned out to be beneficial.

As regards the airflow, there is advantageously no difference as compared to conventional airflow configurations which have proven efficient. However, the airflow can be more easily arranged as a result of the particular arrangement of the planar support wall in the tubular member. In particular, an airflow path may be arranged between the tubular member and the at least one planar support wall. The airflow path may further comprise an air inlet at the first end and/or a flow passage between the airflow path and the internal tubular cavity. The flow passage may be formed in the planar support wall and/or in the closure allowing air to enter in the stick.

In particular, undesired heat transfer to the tubular member (not to the stick) can be minimized due to the fact that contact between the heating element and the tubular member is limited to a line contact for example along suitable rails provided between the tubular member and the heating element.

As regards the number of heater plates, three are currently preferred, but two or four are generally also possible and within the scope of the fourth aspect, as would be a single heater plate or five or more heater plates.

### Fifth Aspect

### Technical Field

The fifth aspect relates to a heating oven for an aerosol generating device.

### Technical Background

Aerosol generating devices have become popular as a replacement for conventional smoking articles, such as cigarettes. In such devices, an aerosol is heated, which is usually achieved by means of a generally tubular oven, around which a thin film heater is wrapped. An aerosol forming article, for example a tobacco substrate stick is inserted into the tubular heater and heated. The conventional thin film heaters require a number of at least partially manual assembling operations.

This also applies to curved heating plates as shown in CN 209995365 U. Further, the method of bringing a moveable heating plate as shown in EP 3 228 199 B1 in contact with a tobacco substrate stick is relatively complicated. CN 109965350 A shows a polygonal support tube with heater plates fixed to the outside.

CN 110638113 A is related to a non-combustion smoking device having a heating film and a vacuum insulation tube on its outer side. Similar devices are known from WO 2020218855 A2, CN 210054651 U and CN 208875408 U.

### Summary of the Fifth Aspect

Against this background, it is an object underlying the fifth aspect to provide an oven for an aerosol generating device which is easy and inexpensive to manufacture and, at the same time, improves heat insulation.

This object is solved by the subject-matter of item 1 of the fifth aspect, according to which the oven has a tubular member and at least one planar support wall extending across the internal tubular cavity thereof. At least one planar heater is attached to the planar support wall, and electrical connections extend through a second end of the tubular member, which can be closed by an appropriate closure. Such an oven turns out to be easy to manufacture and at the same time the necessary heat transfer to a stick inserted into the tubular member can be ensured by means of contact with the support wall, to which the planar heater is attached. Further, the configuration can be simplified by means of the fact that the heater mass can be reduced to the points of contact with the stick. Further, there is, as compared to conventional heating ovens, less need for insulation, as the tubular member acts as a first insulation material.

In particular, undesired heat transfer to the tubular member (not to the stick) can be minimized due to the fact that contact between the planar heater and the tubular member is limited to a line contact for example along suitable rails provided between the tubular member and the planar heater. Further, the tubular member has at least one wall, in which a vacuum is enclosed, so that its insulation properties are further improved. In particular, a vacuum has superior insulation properties, and by integrating it into the wall, the heating oven can still be kept compact. As regards the airflow, there is advantageously no difference as compared to conventional airflow configurations which have proven efficient.

Preferred embodiments of the fifth aspect are described in the further itemized subjects of the fifth aspect.

As regards the materials of at least one wall of the tubular member and the closure, these can be made of heat resistant plastic, such as PEEK, metal, such as stainless steel, or a combination thereof.

The tubular member can for example have a circle cylindrical shape, which further supports the compact size and at the same time enables the required heat transfer to the stick.

In accordance with a simple structure, the planar heater essentially separates a central cavity portion of the tubular member from a peripheral cavity portion thereof, and the central cavity portion is preferably of higher volume than the peripheral cavity portion. In this manner, the central cavity portion can be made sufficiently large for accommodating the stick, and the peripheral cavity portion which allows mounting of the planar heater and contributes to insulation, can be provided but does not significantly increase the size of the tubular member as a whole.

In connection with a relatively simple structure of the planar heater, it can comprise a plate and a heating element attached thereto.

In a particularly efficient manner, the heater can comprise a heater track printed on ceramic material or a metal plate. The heater may also be a resistive heating fibre mat or grid or be a heating layer coated on the plate. The heating coating may be chemically bonded on an electrically insulating material of the plate. For example, the coating of electrically conductive material is metal, metal oxide or carbon. The plate may be a heat resistant plate such as made of PEEK or a metal with a coated of electrically insulating layer as described in co-pending EP21155871.3.

In first simulations, both a structure, in which the heating element faces the central cavity portion, or the alternative structure, in which the heating element faces the peripheral cavity portion has turned out to be efficient for heating a stick accommodated in the central cavity portion. When the heating element faces the central cavity portion, heat transfer can advantageously be maximized.

In order to enable a particularly easy manufacture, the planar support wall can comprise a pair of guiding members, such as rails, configured for insertion of the planar heater therethrough. Similarly, the tubular member can have one or more pair of such guiding members configured for insertion of the support wall. Thus, the tubular member can for example have rails on the inside for allowing insertion of planar heaters and/or planar support walls having at least one planar heater attached thereto. The planar heater can for example be provided as rectangular plates. As regards the number of heater plates, three are currently preferred, but two or four are generally also possible and within the scope of the fifth aspect, as would be a single heater plate or five or more heater plates. Increasing the number of plates allows a better heat distribution. However, there always needs to be a balance between the heat distribution and the complexity of the device. Three or four plates can most likely give that balance depending on the application.

In order to increase heating efficiency and allow individual heating patterns, the tubular member can comprise at least two planar support walls extending across the internal cavity thereof, each planar support wall comprising at least one planar heater. The two planar support walls can be provided in parallel to each other, so that they can efficiently heat the stick from two opposite sides.

In this configuration, the planar heaters can be mounted in series or in parallel, in order to provide different heating patterns. In this context, even when several heaters are provided and are configured to work at the same time, providing them separately simplifies assembly of the oven.

Efficient heating can be provided by both a planar heater, which is resistive and a heating element being inductive, in other words both resistive and/or inductive heaters.

As regards the closure, this can be made of heat resistant plastic, such as PEEK or silicone, metal, such as stainless steel, or a combination thereof, and the shape of a lid or a plug has turned out to be beneficial for the closure.

### BRIEF DESCRIPTION OF THE DRAWINGS

Hereinafter, the invention, i.e. the first aspect, will be described by means of exemplary embodiments thereof and with reference to the drawings. Moreover, hereinafter, the second to fifth aspects of the present disclosure/invention will be described by means of exemplary embodiments thereof and with reference to the drawings. In the drawings

FIG. 1 shows a top view of a heating oven in accordance with the first embodiment (of the invention/first aspect);

FIG. 2 shows a top view of a heating oven in accordance with the second embodiment (of the invention/first aspect);

FIG. 3 shows a schematic perspective view of the first embodiment (of the invention/first aspect);

FIG. 4 shows the heating oven of FIG. 2 in which metal shields are provided;

FIG. 5 shows a top view of a heating oven in accordance with the second aspect;

FIG. 6 shows a side view of a heating oven in accordance with a first embodiment of the second aspect;

FIG. 7 shows side views of a heater used in the embodiments of the second aspect;

FIG. 8 shows a side view of a heating oven in accordance with a second embodiment of the second aspect;

FIG. 9 shows a side view of a heating oven in accordance with a third embodiment of the second aspect;

FIG. 10 shows a side view of a heating oven of the second aspect in which an air-blocking part and an air passage opening are provided;

FIG. 11 shows a perspective sectional view of a part of a heating oven of the second aspect in which an air-blocking part and an air passage opening are provided;

FIG. 12 shows another perspective view of the part of a heating oven shown in FIG. 11;

FIG. 13 shows a partial sectional perspective view of a heating oven of the second aspect in which an air-blocking part and an air passage opening are provided;

FIG. 14 shows a top view of a heating oven in accordance with the third aspect;

FIG. 15 shows a perspective view of a heating oven in accordance with a first embodiment of the third aspect;

FIG. 16 shows a schematic side view of a second embodiment of the third aspect;

FIG. 17 shows a top view of a heater of the fourth aspect;

FIG. 18 shows a schematic perspective view of the heater of FIG. 17;

FIG. 19-21 show top views of support plates in accordance with the fourth aspect;

FIG. 22 shows a top view of a heating oven in accordance with the fifth aspect;

FIG. 23 shows a schematic perspective view of the oven of FIG. 22;

FIG. 24-26 show cut perspective views of different embodiments of a tubular member according to the fifth aspect.

### DETAILED DESCRIPTION OF PREFERRED EMBODIMENTS

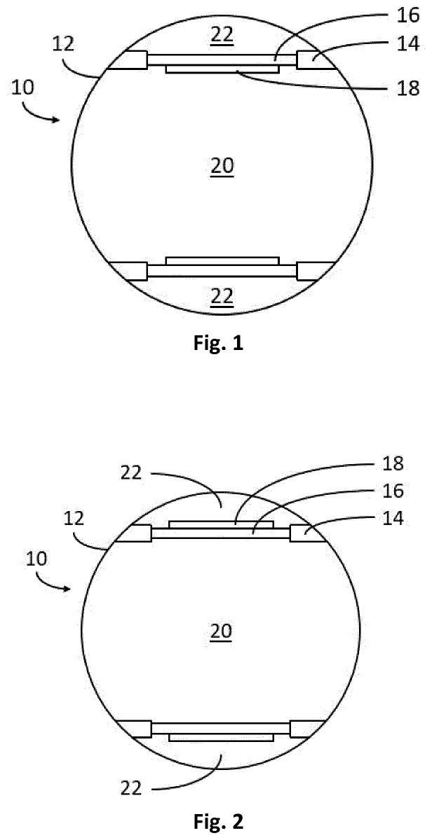

As can be taken from FIG. 1, a heating oven 10 essentially comprises a circle cylindrical tubular member or cup 12 which has, on its inside, two pairs of opposing rails 14 configured to accommodate two essentially planar support walls 16, to which at least one planar heater 18 is attached. The planar support walls 16 are essentially parallel to each other and each separate a relatively large central cavity portion 20 from two peripheral cavity portions 22. In the embodiment shown, the planar heaters are each facing the central cavity portion 20 and are, as a consequence, in direct contact with a tobacco substrate stick, which is not shown. Such direct contact is particularly beneficial for heat transfer to the stick. The stick may be of a diameter larger than the maximum distance between the planar heaters thereby allowing the stick to be deformed and compressed in the insertion position between the heaters.

Nevertheless, also in the embodiment of FIG. 2, which differs from that of FIG. 1 only in that the planar heaters 14 face the peripheral cavity portions 22, sufficient heating of the stick can be ensured.

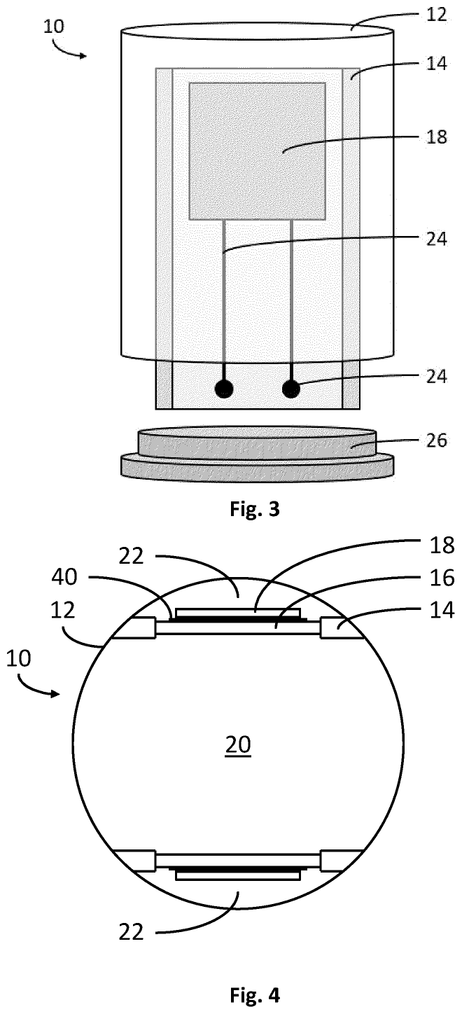

As shown in FIG. 3, any electrical connections 24 extend through the second (lower) end of the cup 12, and this end is, with the connections extending therethrough, closed by means of a plug 26. Each of the planar heaters can be resistive or can be formed as an inductive heating susceptor. The rails and/or planar support wall can extend along the entire or part of the extension between the first and second ends of the cup 12. When they extend along the entire length between the first and second end, the structure as a whole becomes particularly stable.

FIG. 4 shows the same configuration as FIG. 2 with the exception that a metal shield 40 is attached to the planar heater 18 at a side thereof facing the central cavity portion 20. The metal shield can provide protection to the heater when the heater is made of a ceramic body embedding a resistive track. The metal shield 40 could also serve to insert the heater by the edge of the shield sliding along the rails 14 (not shown).

Further details regarding the heating oven in accordance with the present invention and components thereof can be taken from the second to fifth aspects, the disclosure of all of which with regard to the specific components and their features is incorporated herein by means of reference.

### Second Aspect

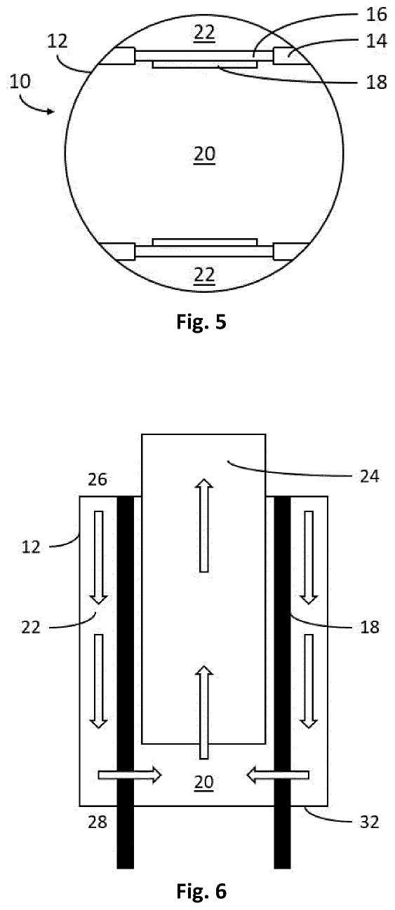

As can be taken from FIG. 5, a heating oven 10 essentially comprises a circle cylindrical tubular member or cup 12 which has, on its inside, two pairs of opposing rails 14 configured to accommodate two essentially planar separation walls 16, to which at least one planar heater 18 is attached. The planar separation walls 16 are essentially parallel to each other and each separate a relatively large central heating cavity 20 from two airflow cavities 22. In the embodiment shown, the planar heaters are each facing the central cavity portion 20 and are, as a consequence, in direct contact with a tobacco substrate stick, which is not shown. Such direct contact is particularly beneficial for heat transfer to the stick.

As shown in FIG. 6, in which, for clarifying reasons, the stick 24 does not contact the heaters 18 as it would be the case in actual use in this particular embodiment, the air flows from the first, open end 26 of the cup 12 towards the second end 28 and enters the heating cavity 20 there. The air then essentially goes on to flow through and along the stick 24 towards the first end 26, where the user can contact the stick 24 with the mouth.

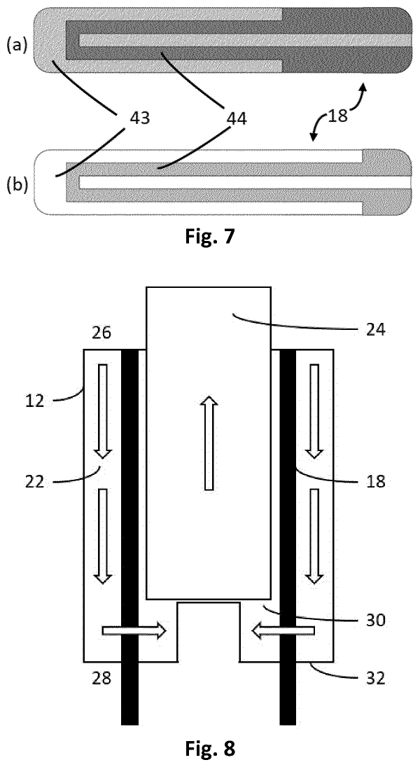

FIG. 7 shows a side view of a planar heater 18 that can be used in the embodiments of the second aspect. While FIG. 7(a) shows the side of the planar heater 18 that faces the central cavity portion 20, FIG. 7(b) shows the side of the planar heater 18 that faces the airflow cavity 22. As can be seen, a structure is provided, in which two heating elements 44 are provided on the plate 43 of the heater 18, so that one heating element 44 is provided on each side of the plate, respectively. In the present case, the plate 43 may be a ceramic plate. As described above, the heating element 44 can be provided as a heater track printed on the ceramic plate 43. As such, a double-sided ceramic heater, having heating elements on both sides thereof can be provided, achieving the above advantages.

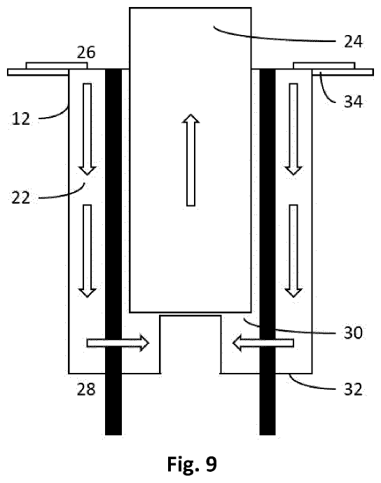

The airflow is essentially identical in the embodiment of FIG. 8, which essentially differs from that of FIG. 5 by a platform 30, which is in this case integral with a closure 32 provided at the second end the platform 30 serves to support the stick 24 but still allows air to enter the stick at the bottom thereof. For this purpose, the platform 30 can have one or more embossing, such as ribs, recesses or protrusions. Despite the central arrow in FIG. 8 air will also pass on the side of the platform since the platform may to some extent block air from entering the stick.

In the embodiment of FIG. 9, a flow control member 34 is indicated, which can for example be a diaphragm which can be activated manually. This can of course also be applied to the embodiment of FIG. 6.

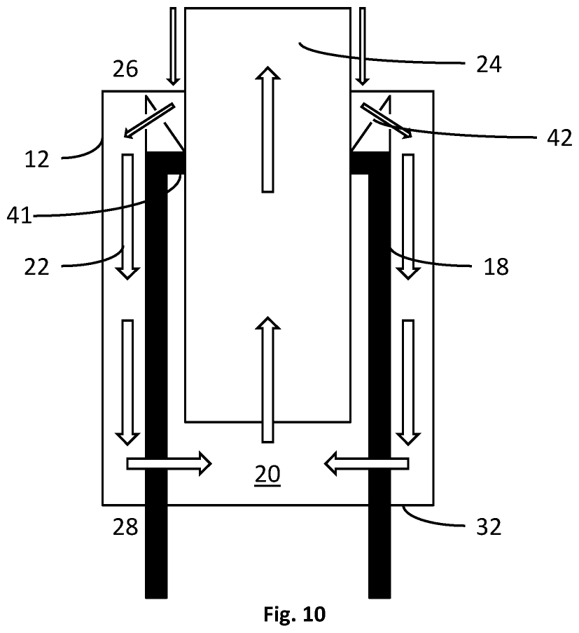

FIG. 10 essentially shows the same configuration of the embodiment shown in FIG. 6 with the exception that an air-blocking part 41 and an air passage opening 42 are provided in the heating oven 10. In FIG. 10, the air-blocking part 41 is an air-blocking ring through which the stick 24 is inserted when the stick is inserted in the heating oven. The separation wall 16 is not shown in FIG. 10. However, it is to be understood that the air-blocking part 41 can be formed as an integral part of the separation wall 16 and the at least one air passage opening 42 can be provided in the separation wall. Alternatively, the air-blocking part 41 can be formed as a portion at a separate part attached to the separation wall 16 and the at least one air passage opening 42 may be provided in the separate part.

In the configuration shown in FIG. 10, the heating oven 10 adopts a configuration in which the at least one air passage opening 42 is provided at a position located further away from a central, longitudinal axis of the tubular member 12 than a contact point between the air-blocking part 41 and the stick 24, when the stick is inserted in the tubular member 12. This allows air from the outside (indicated by the white arrows) to enter the peripheral cavity portion (airflow cavity) 22 through the air passage opening 42, through an air passage in the heating oven formed in a region behind the air-blocking part 41, as seen in a direction from the central, longitudinal axis of the tubular member, i.e. in a region between the air-blocking part 41 and the tubular member 12.

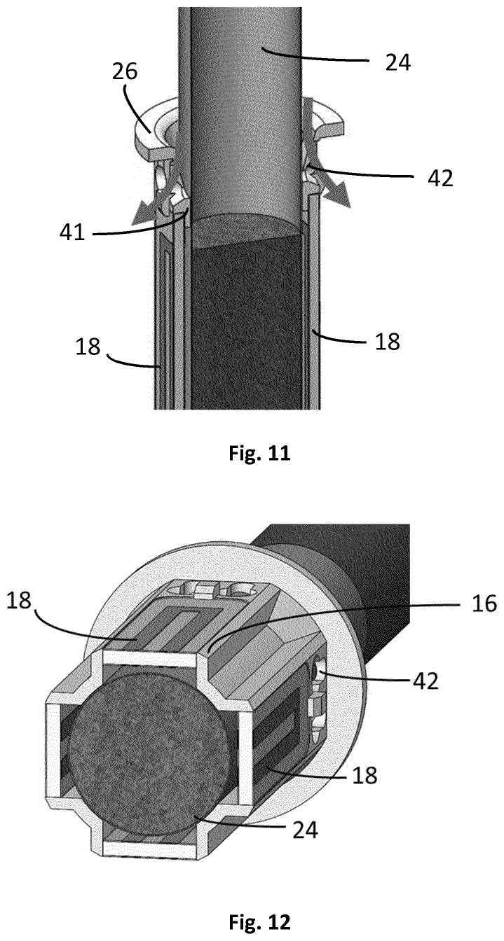

FIG. 11 shows a perspective sectional view of a part of a heating oven 10 of the second aspect in which an air-blocking part 41 and an air passage opening 42 are provided. In FIG. 11, the air-blocking part 41 is again an air-blocking ring through which the stick 24 is inserted when the stick is inserted in the heating oven 10. Also shown are two planar heaters 18.

As in case of FIG. 10, the heating oven 10 adopts a configuration in which the at least one air passage opening 42 is provided at a position located further away from a central, longitudinal axis of the tubular member 12 than a contact point between the air-blocking part 41 and the stick 24, when the stick is inserted in the tubular member 12. In this particular embodiment, the air flow, which is indicated by the two arrows in FIG. 11, is similar to the schematic illustration of FIG. 10. That is, the air enters the heating oven 10 via the air passage openings 42 provided at the first end 26 of the tubular member 12 and is then guided downwards, along the direction along the longitudinal axis of the tubular member 12 and over the side of the planar heaters 18 facing the airflow cavity 22.

FIG. 12 shows another perspective view of the part of the heating oven 10 shown in FIG. 11. Four heaters 18 are provided, circumferentially equally spaced apart from each other by a separation wall 16 structure in the form of ridges between the heaters. With this structure, the heaters 18 can be arranged around the tobacco stick 24 with the heaters 18 being spaced apart from the stick 24, when the stick is inserted in the tubular member 12. For example, a smallest distance between the stick and the heater in a direction perpendicular to the direction along the longitudinal axis of the tubular member may be at least 0.1 mm, preferably at least 0.3 mm, more preferably at least 0.5 mm, and most preferably at least 0.7 mm, preferably less than 1.5 mm, more preferably less than 1.2 mm, most preferably about (1.0+/−0.1) mm. With this configuration, a more homogeneous heating of the stick can be achieved. Moreover, this configuration prevents overheating of parts of the stick, reduces off-taste, and can improve the quality of the emissions of the aerosol generating device.

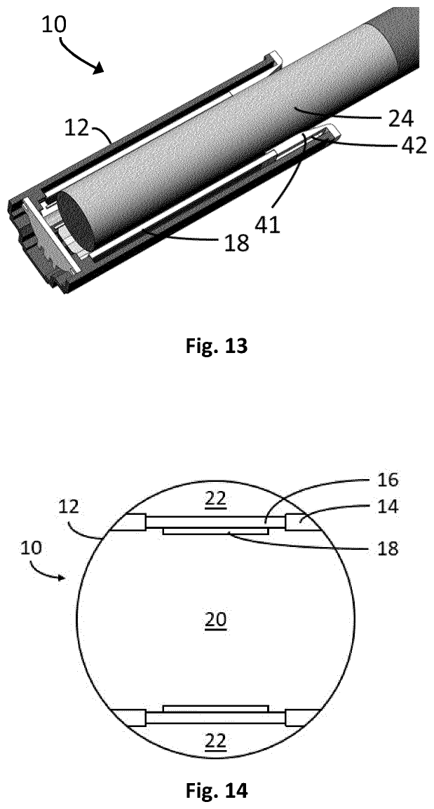

FIG. 13 shows a partial sectional perspective view of a heating oven 10 of the second aspect in which an air-blocking part 41 and an air passage opening 42 are provided. Also shown in FIG. 13 is the tubular member 12. The configuration of the air-blocking part 41, the air passage opening 42, and the heaters 18, as well as the air flow created in the device is the same as described with respect to FIGS. 11 and 12.

Further details regarding the heating oven in accordance with the second aspect and components thereof can be taken from the first and third to fifth aspects, the disclosure of all of which with regard to the specific components and their features is incorporated herein by means of reference.

### Third Aspect

As can be taken from FIG. 14, a heating oven 10 essentially comprises a circle cylindrical tubular member or cup 12 which has, on its inside, two pairs of opposing rails 14 configured to accommodate two essentially planar support walls 16, to which at least one planar heater 18 is attached. The planar support walls 16 are essentially parallel to each other and each separate a relatively large central cavity portion 20 from two peripheral cavity portions 22. In the embodiment shown, the planar heaters are each facing the central cavity portion 20 and are, as a consequence, in direct contact with a tobacco substrate stick, which is not shown. In particular, by selecting a stick with a larger transversal dimension than the distance separating the planar heaters 18, the stick is maintained in compression inside the cavity portion 20. Such direct contact, and possible compression by deformation of the stick, are particularly beneficial for heat transfer to the stick.

Nevertheless, also in an embodiment, in which the planar heaters 14 face the peripheral cavity portions 22, sufficient heating of the stick can be ensured.

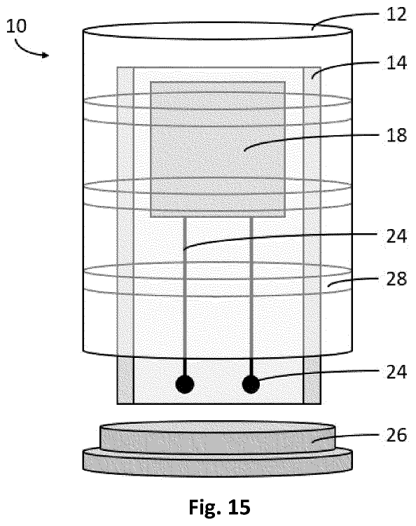

As shown in FIG. 15, any electrical connections 24 extend through the second (lower) end of the cup 12, and this end is, with the connections extending therethrough, closed by means of a plug 26. Each of the planar heaters can be resistive or can be formed as an inductive heating susceptor. The rails and/or planar support wall can extend along the entire or part of the extension between the first and second end of the cup 12. When they extend along the entire length between the first and second end, the structure as a whole becomes particularly stable.

Moreover, in the case shown, three clamping rings 28 are indicated for mechanically fixing the planar support wall 16.

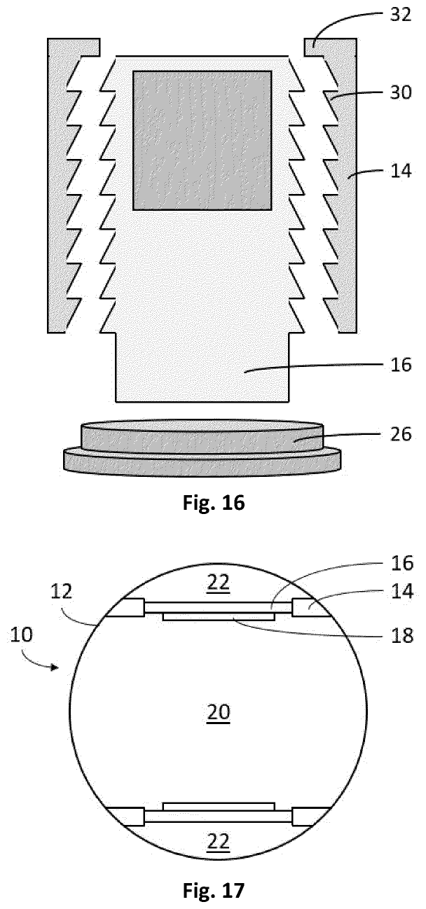

As can be taken from FIG. 16, this can also be achieved by means of a pair of rails having lugs 30 or projection similar to those used in cable ties. In other words, they provide less resistance in one direction, for example, from the bottom to the top in FIG. 16, than in the opposite direction. In this manner, the planar support wall 16 inserted between the rails in the first direction mentioned above can be inserted without excessive force, in particular, until it reaches a stop 32 provided in the case shown on each of the rails 14.

However, in the opposite direction, i.e. towards the bottom of FIG. 16, the resistance is much higher, and the planar support wall can in particular be locked, so that any undesired movement in this direction is prevented. This is further supported by the plug 26 close to that end, through which the planar support wall 16 has been inserted. In summary, a robust and easy to manufacture heating oven for an aerosol generating device can be provided.

Further details regarding the heating oven in accordance with the third aspect and components thereof can be taken from the first, second, fourth, and fifth aspects, the disclosure of all of which with regard to the specific components and their features is incorporated herein by means of reference.

### Fourth Aspect

As can be taken from FIG. 17, a heater 10 essentially comprises a circle cylindrical tubular member or cup 12 which has, on its inside, two pairs of opposing rails 14 configured to accommodate two support plates 16, to which at least one heating element 18 is attached. The support plates 16 are essentially parallel to each other and each separate a relatively large central cavity portion 20 from two peripheral cavity portions 22. In the embodiment shown, the heating elements are each facing the central cavity portion 20 and are, as a consequence, in direct contact with a tobacco substrate stick, which is not shown. Such direct contact is particularly beneficial for heat transfer to the stick.

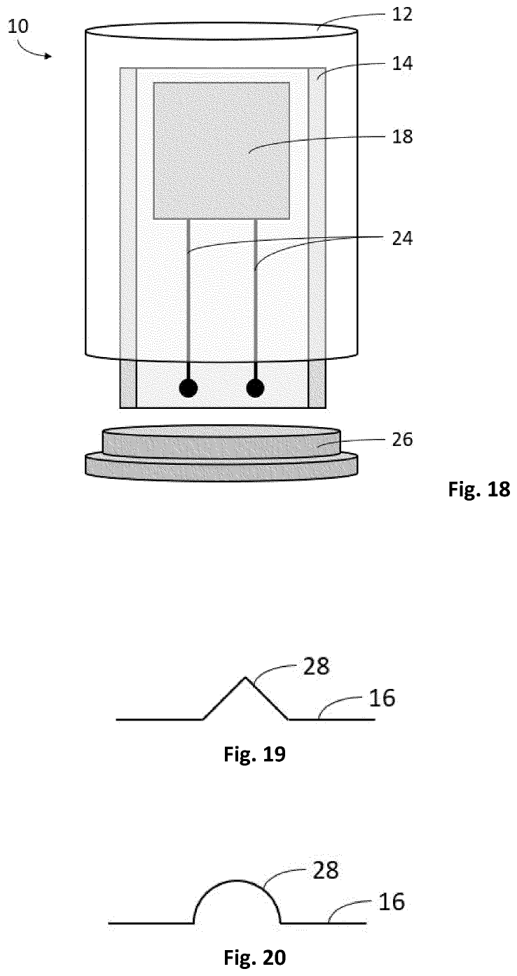

As shown in FIG. 18, any electrical connections 24 extend through the second (lower) end of the cup 12, and this end is, with the connections extending therethrough, closed by means of a plug 26. Each of the heating elements can be resistive or can be formed as an inductive heating susceptor. The rails and/or support plate can extend along the entire or part of the extension between the first and second end of the cup 12.

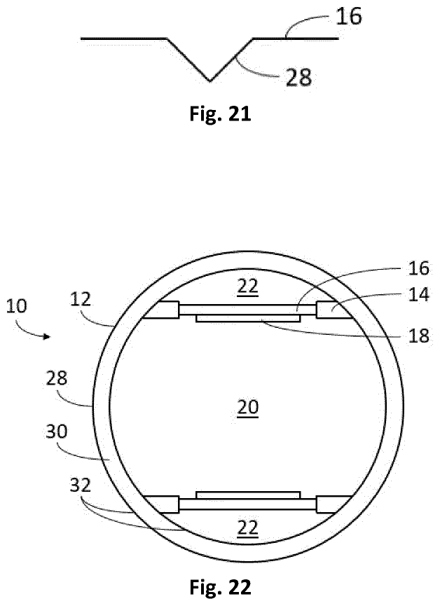

As can also be taken from FIGS. 19 to 21, the heating element 18 is typically smaller than the support plate 16 and can overlap with an embossing 28, in the embodiment shown extending in the length direction of the heater. In all of the embodiments shown, the embossing has a maximum height, in other words, an extension or protrusion extending from the largest surface of the support plate 16, which is significantly larger than the thickness of the support plate 16. In the embodiment of FIGS. 19 and 21, the embossing is essentially V-shaped and covers approximately one third to one fourth of the width dimension of the plate.

This also applies to the embodiment of FIG. 20, in which the embossing is U- or bowl-shaped. Any embossing can also extend in the width direction and can, in any case, increase rigidity of the support plate.

Further details regarding the heating oven in accordance with the fourth aspect and components thereof can be taken from the first to third and fifth aspects, the disclosure of all of which with regard to the specific components and their features is incorporated herein by means of reference.

### Fifth Aspect

As can be taken from FIG. 22, a heating oven 10 essentially comprises a circle cylindrical tubular member or cup 12 which has, on its inside, two pairs of opposing rails 14 configured to accommodate two essentially planar support walls 16, to which at least one planar heater 18 is attached. The planar support walls 16 are essentially parallel to each other and each separate a relatively large central cavity portion 20 from two peripheral cavity portions 22. In the embodiment shown, the planar heaters are each facing the central cavity portion 20 and are, as a consequence, in direct contact with a tobacco substrate stick, which is not shown. Such direct contact is particularly beneficial for heat transfer to the stick.

As can also be seen in FIG. 22, in a wall 28 of the cup 12, a vacuum 30 is enclosed, which significantly improves the heat insulation properties of the cup 12. In the case shown, the vacuum 30 is defined by two concentric wall portions 32 of the wall 28.

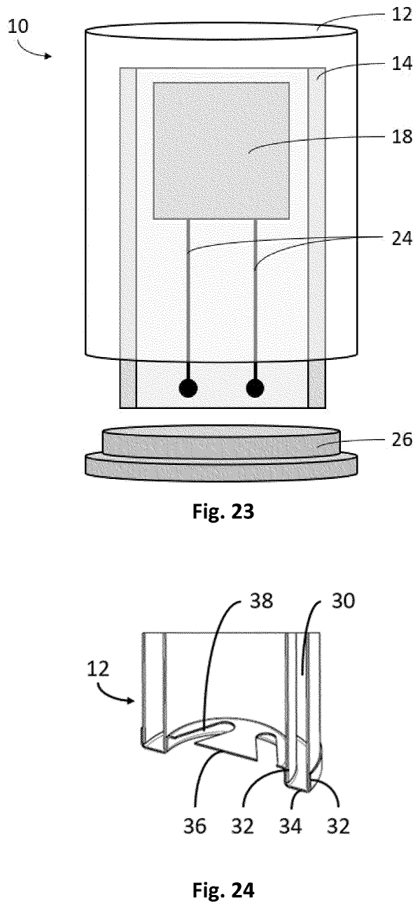

As shown in FIG. 23, any electrical connections 24 extend through the second (lower) end of the cup 12, and this end is, with the connections extending therethrough, closed by means of a plug 26. Each of the planar heaters can be resistive or can be formed as an inductive heating susceptor. The rails and/or planar support wall can extend along the entire or part of the extension between the first and second end of the cup 12. When they extend along the entire length between the first and second end, the structure as a whole becomes particularly stable.

FIG. 24 shows an, according to FIG. 23, lower end of the tubular member 12 with the two wall portions 32, between which the vacuum 30 is enclosed. In the embodiment shown, the annular bottom 34 between the wall portions 32 is formed by a component having two short collars overlapping with the wall portions 32 and being attached thereto.

Within the inner wall portion 32 there is a circular base 36 with elongate openings 38 for allowing the electrical connections 24 to pass through. Although not visible in FIG. 24, a third opening 38 can for example be provided so as to form an isosceles triangle together with the two openings 38 visible in FIG. 24.

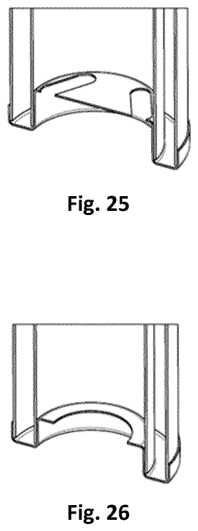

FIG. 25 indicates that the circular base 36 can also be at a location further away from the end of the wall portions 32, and according to FIG. 26 a single, circular opening 38 can be provided.

Further details regarding the heating oven in accordance with the fifth aspect and components thereof can be taken from the first to fourth aspects, the disclosure of all of which with regard to the specific components and their features is incorporated herein by means of reference.

### Itemized Subjects of Second to Fifth Aspects

The following itemized subjects pertaining to the second to fifth aspects also form part of the present disclosure/invention.

The itemized subjects pertaining to one aspect may be independent from the itemized subjects pertaining to another aspect or may be combined with the itemized subjects pertaining to the other aspect. In addition, the itemized subjects pertaining to one aspect may be independent from the subject-matter of the claims pertaining to the invention, i.e. the first aspect, or may be combined with the subject-matter of the claims pertaining to the invention.

### Second Aspect

1. A heating oven (10) for an aerosol generating device comprising:
   a tubular member (12) comprising an internal tubular cavity extending along a longitudinal axis and comprising a first end (26) and a second end (28),
   a closure (22) at least partially closing at the second end (28),
   at least one separation wall (16) fixed to and extending across the internal tubular cavity of the tubular member (12) and in the direction of the longitudinal axis at least partially between the first and second ends (28),
   wherein the separation wall (16) separates a heating cavity (20) for insertion of an aerosol generating article from an airflow cavity (22);
   wherein the airflow cavity (22) is open at the first end (26) of the tubular member (12) and wherein the air flow cavity communicates with the heating cavity (20) at the second end (28) so as to allow air to flow from the airflow cavity (22) to the heating cavity (20), and wherein the separation wall (16) comprises at least one heater (18).
2. Heating oven (10) according to item 1, wherein the separation wall (16) is planar.
3. Heating oven (10) according to item 1, wherein it comprises a second separation wall (16) to form a second airflow cavity (22) separate from the first airflow cavity (22).
4. Heating oven (10) according to item 3, wherein the separation wall (16) comprises a second heater (18).
5. Heating oven (10) according to items 3 and 4, wherein the first and second separation walls (16) are opposed and preferably symmetrically arranged on each side of a longitudinal axial plane of the tubular member (12).
6. Heating oven (10) according to any one of items 2 to 5, wherein the first and second separation walls (16) are mounted in side rails of the tubular member (12) extending parallel to the longitudinal axis of the tubular member (12).
7. Heating oven (10) according to any one of items 2 to 6, wherein the heater (18) comprises a plate and a heating element attached thereto.
8. Heating oven (10) according to any one of items 2 to 7, wherein it comprises a flow control member configured for varying the flow section of the air flow cavity.
9. Heating oven (10) according to item 8, wherein the flow control member is manually movable between a first flow section and a second flow section of reduced pressure drop.
10. Heating oven (10) according to item 9, wherein the flow control member is rotatable.
11. Heating oven (10) according to any one of the preceding items, wherein the tubular member (12) is formed of a deep drawn piece of metal such as steel or aluminium.
12. Heating oven (10) according to any one of the preceding items, wherein the closure (22) is formed of a separate element mechanically attached or welded to the tubular member (12) or be an integral part of the tubular member (12).
13. Aerosol generating device comprising a control unit, an electrical supply unit and a housing comprising an oven according to any one of the preceding items.
14. Aerosol generating device according to item 12, wherein the oven is surrounded by a thermal insulating member.
15. Aerosol generating system comprising an aerosol generating device according to any one of the preceding items 1 to 10 and an aerosol substrate in the form of a rod at least partially inserted in the heating oven (10); the aerosol substrate being sized to be deformed and compressed by the separation wall (16) or separation walls (16).

### Third Aspect

1. A heating oven (10) for an aerosol generating device comprising:
   a tubular member (12) comprising a cavity (20, 22) for insertion of a rod-type aerosol generating substrate, a first end open to receive the substrate and a second end and
   at least one planar support wall (16) extending across the interior of the tubular member (12) between the first and second ends to at least partially demarcate the cavity (20, 22),
   at least one heater (18) attached to the planar support wall (16),
   wherein the planar support wall (16) is fixed to tubular member (12) by means of a mechanical fixture.
2. Heating oven (10) according to item 1, wherein the heater (18) comprises a plate and a heating element, such as a heating track, attached thereto.
3. Heating oven (10) according to item 1 or 2, wherein the tubular member (12) comprises internal guiding members, such as rails (14) configured for insertion of the planar support wall (16) therebetween.
4. Heating oven (10) according to any one of items 1 to 3, wherein the tubular member (12) and/or planar support wall (16) is formed of resilient material.
5. Heating oven (10) according to item 4, wherein the tubular member (12) and/or planar support wall (16) is formed of PEEK.
6. Heating oven (10) according to any one of items 1 to 5, wherein the mechanical fixture is a clamping fixture.
7. Heating oven (10) according to item 6, wherein the mechanical fixture comprises at least two clamping rings (28) spaced apart along the axial length of the tubular member (12).
8. Heating oven (10) according to item 7, wherein the clamping ring(s) is/are self-locking.
9. Heating oven (10) according to any one of items 1 to 8, wherein the tubular member (12) comprises at least two planar support walls (16) extending across the internal tubular cavity (20, 22) of the tubular member (12) between the first and second ends, each planar support wall (16) comprising at least one heater (18).
10. Heating oven (10) according to any one of items 1 to 9, further comprising a closure, such as a lid or plug (26).
11. Heating oven (10) according to any one of items 1 to 10, wherein it comprises a second planar support wall (16) to demarcate the cavity (20).
12. Heating oven (10) according to item 11, wherein the second planar support wall (16) comprises a second heater (18).
13. Heating oven (10) according to item 11 or 12, wherein the first and second planar support wall (16) are opposed and preferably symmetrically arranged on each side of a longitudinal axial plane of the tubular member (12).
14 Aerosol generating device comprising a control unit, an electrical supply unit and a housing comprising a heating oven (10) according to any one of the preceding items.
15. Aerosol generating device according to item 14, wherein the oven is surrounded by a thermal insulating member.

### Fourth Aspect

1. A heater (10) for an aerosol generating device comprising a support plate (16) and a heating element (18) attached on a surface of the support plate (16) wherein the support plate (16) is substantially cuboid with a length, a width and a thickness wherein the thickness is smaller than the length and the width and wherein the support plate (16) presents locally at least one embossing.
2. Heater (10) according to item 2, wherein the support plate (16) is made of metal, preferably stainless steel, a high heat resistant plastic, such as PEEK or a combination thereof.
3. Heater (10) according to any one of items 1 to 2, wherein the support plate (16) has a thickness lower than 0.5 mm, preferably lower than 0.1 mm most preferably of about 0.07 mm.
4. Heater (10) according to any one of items 1 to 3, wherein the embossing has a rib a length of which extends in the length direction and its depth extends in the thickness direction of the heater (10).
5. Heater (10) according to any one of items 1 to 4, wherein the support plate (16) has a rib protruding in a direction of the surface of the wall which the heating element (18) is attached to or in direction of the surface of the wall opposite to the surface which the heating element (18) is attached to.
6. Heater according to item 5, wherein the rib is V- or U-shaped as seen in a cross section.
7. Heater (10) according to any one of items 4 to 6, wherein the heating element (18) and the rib at least partially overlap when seen in the direction of thickness.
8. Heater (10) according to any one of items 1 to 7, wherein the heating element (18) is resistively or inductively heatable.
9. Heater (10) according to any one of items 1 to 8, wherein it comprises an electrically insulating layer between the support plate (16) and the heating element (18).
10. Heater (10) according to item 9, wherein the electrically insulating layer is an electrically insulating polymer or ceramic or DLC.
11. Heater (10) according to one of the preceding items, the embossing having a maximum height larger than the thickness of the support plate (16).
12. An aerosol generating device with a heating oven comprising a heater (10) according to any of the preceding items and a tubular member (12) comprising a first end and a second end and at least one heater (10) according to any of the preceding items, wherein the heater (10) extends in the tubular member (12) between the first and second ends.
13. Aerosol generating device according to item 12, wherein the heater (10) is attached to the inner wall of the tubular member (12).
14. Aerosol generating device according to item 12 or 13, wherein the length of the heater (10) extends along the axial direction of the tubular member (12).
15. Aerosol generating device according to any one of items 12 to 14, wherein the heater (10) separates a central cavity portion (20) of the tubular member (12) for receiving an aerosol forming substrate from a peripheral cavity portion (22) of the tubular member (12).

### Fifth Aspect

1. A heating oven (10) for an aerosol generating device comprising a tubular member (12) comprising at least one wall (28), in which a vacuum (30) is enclosed, and at least one planar heater (18) extending across an internal tubular cavity of the tubular member (12), wherein at least one planar heater (18) is attached to a planar support wall (16), which comprises electrical connections (24) extending through a second end of the tubular member (12) and at least one closure (26) is configured for at least partially closing the second end.
2. Heating oven (10) according to item 1, wherein at least one wall (28) is made from metal.
3. Heating oven (10) according to items 1 or 2, wherein at least one wall (28) is made from a high temperature resistant plastic material such as PEEK.
4. Heating oven (10) according to any one of items 1 to 3, wherein the tubular member (12) is circular cylindrical.
5. Heating oven (10) according to any one of the preceding items, wherein a central cavity portion (20) of the tubular member (12) is of higher volume than a peripheral cavity portion (22).
6. Heating oven (10) according to any one of the preceding items, wherein the planar heater (18) comprises a plate and a heating element attached thereto.
7. Heating oven (10) according to item 6, wherein the planar heater (18) comprises a heater track printed on ceramic or metal plate.
8. Heating oven (10) according to item 6 or 7, wherein the heating element faces the central cavity portion (20) or the peripheral cavity portion (22).
9. Heating oven (10) according to any one of the preceding items, wherein the planar support wall (16) comprises a pair of guiding members, such as rails (14), configured for insertion of the planar heater (18) therethrough.
10. Heating oven (10) according to any one of the preceding items, wherein the tubular member (12) comprises at least two planar support walls (16) extending across the internal tubular cavity of the tubular member (12) between the first and second ends; each planar support wall (16) comprising at least one planar heater (18).
11. Heating oven (10) according to item 10, wherein the planar heater (18)s are mounted in series or in parallel.
12. Heating oven (10) according to any one of the preceding items, wherein the planar heater (18) is resistive or inductive.
13. Heating oven (10) according to any one of the preceding items, wherein the closure (26) is made of a high temperature resistant plastic material such as PEEK, metal or a combination thereof.
14. Heating oven (10) according to any one of the preceding items, wherein the closure (26) is a lid or plug.

1. A heating oven for an aerosol generating device comprising:
a tubular member comprising a first end and a second end and at least one planar support wall extending across an internal tubular cavity of the tubular member between the first and second ends,
at least one planar heater attached to the at least one planar support wall comprising electrical connections extending through the second end of the tubular member and,
at least one closure configured for at least partially closing the second end.

2. The heating oven according to claim 1, wherein the at least one planar heater separates a central cavity portion of the tubular member from a peripheral cavity portion of the tubular member.

3. The heating oven according to claim 2, wherein the central cavity portion of the tubular member is of higher volume than the peripheral cavity portion.

4. The heating oven according to claim 2, wherein each of the at least one planar heaters comprises a plate and a heating element attached thereto.

5. The heating oven according to claim 1, wherein each of the at least one planar heaters comprises a heater track printed on a ceramic or metal plate.

6. The heating oven according to claim 4, wherein the heating element of each of the at least one planar heaters faces the central cavity portion.

7. The heating oven according to claim 4, wherein the heating element of each of the at least one planar heaters faces the peripheral cavity portion.

8. The heating oven according to claim 1, wherein the at least one planar support wall comprises a pair of guiding members configured for insertion of the at least one planar heater therethrough.

9. The heating oven according to claim 1, wherein the at least one planar support wall comprises at least two planar support walls extending across the internal tubular cavity of the tubular member between the first and second ends; each of the at least two planar support walls comprising at least one of the at least one planar heaters.

10. The heating oven according to claim 9, wherein the at least one planar heaters are mounted in series or in parallel.

11. The heating oven according to claim 1, wherein each of the at least one planar heaters is resistive or inductive.

12. The heating oven according to claim 1, wherein the tubular member and/or the at least one closure is made of high heat resistant plastic, metal, or a combination thereof.

13. The heating oven according to claim 1, wherein the at least one closure is a lid or plug.

14. An aerosol generating device having at least one heating oven according to claim 1.

15. A method of assembling a heating oven for an aerosol generating device, comprising:
providing a tubular member having two open ends,
inserting at least one planar support wall having a planar heater attached thereto through one of the two open ends, and
closing one of the two open ends with electrical connections extending through a closure.

16. The heating oven according to claim 1, wherein the at least one planar support wall comprises a pair of rails configured for insertion of the at least one planar heater therethrough.

17. The heating oven according to claim 12, wherein the high heat resistant plastic is PEEK.

18. The heating oven according to claim 12, wherein the metal is stainless steel.
